(19) United States
(12) Patent Application Publication
(10) Pub. No.: US 2020/0165713 A1
(43) Pub. Date: May 28, 2020

(54) FREESTANDING CERAMIC SEAL FOR A GAS TURBINE

(71) Applicant: General Electric Company, Schenectady, NY (US)

(72) Inventors: Venkat Subramaniam VENKATARAMANI, Clifton Park, NY (US); Anthony Christopher MARIN, Saratoga Springs, NY (US); Neelesh Nandkumar SARAWATE, Niskayuna, NY (US); Stephen Francis BANCHERI, Albany, NY (US); Larry Steven ROSENZWEIG, Niskayuna, NY (US)

(21) Appl. No.: 16/632,648

(22) PCT Filed: Jul. 18, 2017
(86) PCT No.: PCT/US2017/042498

§ 371 Date: Jan. 21, 2020

(51) Int. Cl. C23C 4/11; C23C 4/134; C23C 4/18; F02C 7/28

(52) U.S. Cl. CPC C23C 4/11; C23C 4/134; C23C 4/185; F05D 2230/312; F05D 2220/32; F05D 2240/55; F02C 7/28

(57) ABSTRACT

Various embodiments include a gas turbine seal and methods of forming such seal. The method of forming the seal includes forming a freestanding ceramic seal for sealing in a gas turbine by applying a ceramic material on a substrate to form a ceramic layer, removing the substrate from the ceramic layer and finishing the ceramic layer to define the freestanding ceramic seal. The method includes depositing particles of the ceramic material in one of a molten or vapor state on a surface of the substrate and quenching the ceramic material to form the ceramic layer. The ceramic material comprises yttria-stabilized zirconia having a t′ tetragonal structure. A gas turbine including the freestanding ceramic seal is additionally disclosed.

### BACKGROUND

The subject matter disclosed herein relates to turbines. Specifically, the subject matter disclosed herein relates to seals in gas turbines.

The main gas-flow path in a gas turbine commonly includes the operational components of a compressor inlet, a compressor, a turbine and a gas outflow. There are also secondary flows that are used to cool the various heated components of the turbine. Mixing of these flows and gas leakage in general, from or into the gas-flow path, is detrimental to turbine performance. Leakage of cooling flows between turbine components generally causes reduced power output and lower efficiency. Leaks may be caused by thermal expansion of certain components and relative movement between components during operation of the gas turbine. Leakage of high pressure cooling flows into the hot gas path thus may lead to detrimental parasitic losses. Overall efficiency thus may be improved by blocking the leakage locations with seal components, while providing cooling flows only as required. Current gas turbine seals use many different combinations and configurations of metal seals to achieve such leakage control. For example, spline seals may be used between adjacent stator parts in a ring assembly of a gas turbine.

Gas turbines and engines are slated to function at temperatures above 1800° F., and typically at temperatures between 2200° F.-2700° F. As such, many of the turbine components may be formed of advanced materials, such as ceramic matrix composites (CMCs). Traditional metal seals made from special alloys such as Haynes 288, 214 are not suitable for applications with exposure to temperatures above 1800° F. due to accelerated failure from creep, oxidation and high temperature corrosion. In addition, metal seals may react with the CMC components at high temperatures.

Directionally solidified and/or single crystal nickel based super alloys are often used in the manufacture of turbine blades for high temperature applications, but have been found difficult and expensive to fabricate into the thin seals required for these applications. In addition, seals of this type material would still require the formation of a thermal barrier layer over a bond coat to prevent oxidation when exposed to harsh environments at high temperatures. Accordingly, fabrication of seals to include this three layer composite structure is not scalable, and thus not been a viable option.

There is thus a desire for an improved seal, such as a spline seal, for use in gas turbine parts exposed to harsh environments at high temperatures. In addition there is a desire for an improved seal for use in conjunction with gas turbine CMC components. Such a seal should be high temperature resistant, wear resistant, and sufficiently flexible so as to provide adequate sealing with a long component lifetime.

### BRIEF DESCRIPTION

Various embodiments of the disclosure include gas turbine seals and methods of forming such seals. In accordance with one exemplary embodiment, disclosed is a method of forming a freestanding ceramic seal for sealing in a gas turbine including applying a ceramic material on a substrate to form a ceramic layer; removing the substrate from the ceramic layer; and finishing the ceramic layer to define the freestanding ceramic seal.

In accordance with another exemplary embodiment, disclosed is a freestanding ceramic seal to seal a gas turbine hot gas path flow in a gas turbine. The freestanding ceramic seal is comprised of yttria-stabilized zirconia (YSZ).

In accordance with yet another exemplary embodiment, disclosed is a gas turbine including a first arcuate component adjacent to a second arcuate component, each arcuate component including one or more slots located in an end face; and a seal disposed in the slot of the first arcuate component and the slot of the second arcuate component. The seal including a free-standing ceramic seal comprised of yttria-stabilized zirconia (YSZ) having a t′ tetragonal structure.

Other objects and advantages of the present disclosure will become apparent upon reading the following detailed description and the appended claims with reference to the accompanying drawings. These and other features and improvements of the present application will become apparent to one of ordinary skill in the art upon review of the following detailed description when taken in conjunction with the several drawings and the appended claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a perspective partial cut-away view of a known gas turbine;

FIG. 2 shows a perspective view of exemplary arcuate components of the gas turbine of FIG. 1, in an annular arrangement;

FIG. 3 shows a partial cross-sectional longitudinal view of a known turbine of a gas turbine;

FIG. 4 shows a schematic cross-sectional view of a portion of a turbine, in accordance with one or more embodiments shown or described herein;

FIG. 5 shows a step in a method of forming a freestanding ceramic seal, in accordance with one or more embodiments shown or described herein;

FIG. 6 shows a step in a method of forming a freestanding ceramic seal, in accordance with one or more embodiments shown or described herein;

FIG. 7 shows a step in a method of forming a freestanding ceramic seal, in accordance with one or more embodiments shown or described herein;

FIG. 8 shows a step in a method of forming a freestanding ceramic seal, in accordance with one or more embodiments shown or described herein; and

FIG. 9 shows a flow diagram illustrating a method of forming a freestanding ceramic seal, in accordance with one or more embodiments shown or described herein.

It is noted that the drawings as presented herein are not necessarily to scale. The drawings are intended to depict only typical aspects of the disclosed embodiments, and therefore should not be considered as limiting the scope of the disclosure. In the drawings, like numbering represents like elements between the drawings.

### DETAILED DESCRIPTION

As noted herein, the subject matter disclosed relates to turbines. Specifically, the subject matter disclosed herein relates to the sealing within such turbines.

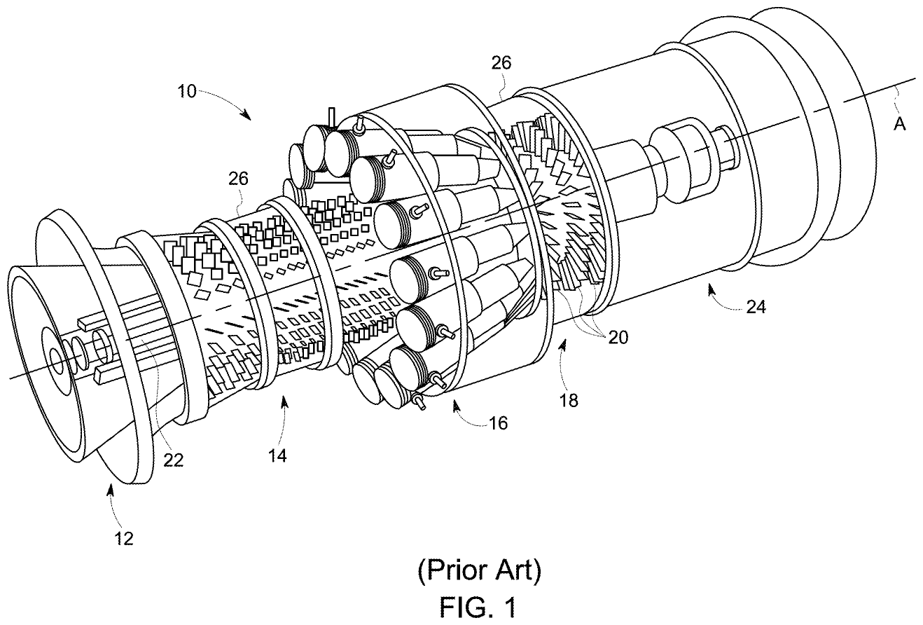

As denoted in these Figures, the “A” axis (FIG. 1) represents axial orientation (along the axis of the turbine rotor). As used herein, the terms “axial” and/or “axially” refer to the relative position/direction of objects along the axis A, which is substantially parallel with the axis of rotation of the turbomachine (in particular, the rotor section). As further used herein, the terms “radial” and/or “radially” refer to the relative position/direction of objects along an axis (not shown), which is substantially perpendicular with axis A and intersects axis A at only one location. Additionally, the terms “circumferential” and/or “circumferentially” refer to the relative position/direction of objects along a circumference (not shown) which surrounds axis A but does not intersect the axis A at any location. It is further understood that common numbering between the various Figures denotes substantially identical components in the Figures.

Referring to FIG. 1, a perspective view of one embodiment of a gas turbine 10 is shown. In this embodiment, the gas turbine 10 includes a compressor inlet 12, a compressor 14, a plurality of combustors 16, a compressor discharge (not shown), a turbine 18 including a plurality of turbine blades 20, a rotor 22 and a gas outflow 24. The compressor inlet 12 supplies air to the compressor 14. The compressor 14 supplies compressed air to the plurality of combustors 16 where it mixes with fuel. Combustion gases from the plurality of combustors 16 propel the turbine blades 20. The propelled turbine blades 20 rotate the rotor 22. A casing 26 forms an outer enclosure that encloses the compressor inlet 14, the compressor 14, the plurality of combustors 16, the compressor discharge (not shown), the turbine 18, the turbine blades 20, the rotor 22 and the gas outflow 24. The gas turbine 10 is only illustrative; teachings of the disclosure may be applied to a variety of gas turbines.

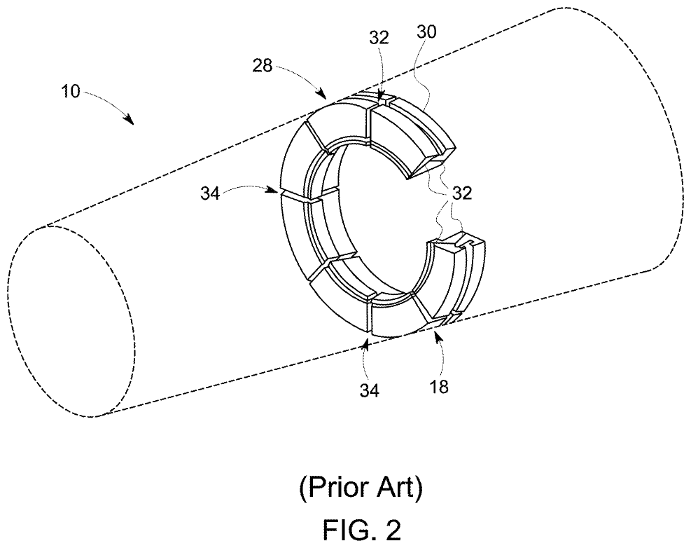

In an embodiment, stationary components of each stage of a hot gas path (HGP) of the gas turbine 10 consists of a set of nozzles (stator airfoils) and a set of shrouds (the static outer boundary of the HGP at the rotor airfoils 20). Each set of nozzles and shrouds are comprised of numerous arcuate components arranged around the circumference of the hot gas path. Referring more specifically to FIG. 2, a perspective view of one embodiment of an annular arrangement 28 including a plurality of arcuate components 30 of the turbine 18 of the gas turbine 10 is shown. In the illustrated embodiment, the annular arrangement 28 as illustrated includes seven arcuate components 30 with one arcuate component removed for illustrative purposes. Between each of the arcuate components 30 is an inter-segment gap 33. This segmented construction is necessary to manage thermal distortion and structural loads and to facilitate manufacturing and assembly of the hardware.

A person skilled in the art will readily recognize that annular arrangement 28 may have any number of arcuate components 30; that the plurality of arcuate components 30 may be of varying shapes and sizes; may include metal and/or CMC components; and that the plurality of arcuate components 30 may serve different functions in gas turbine 10. For example, arcuate components in a turbine may include, but not be limited to, outer shrouds, inner shrouds, nozzle blocks, and diaphragms as discussed below.

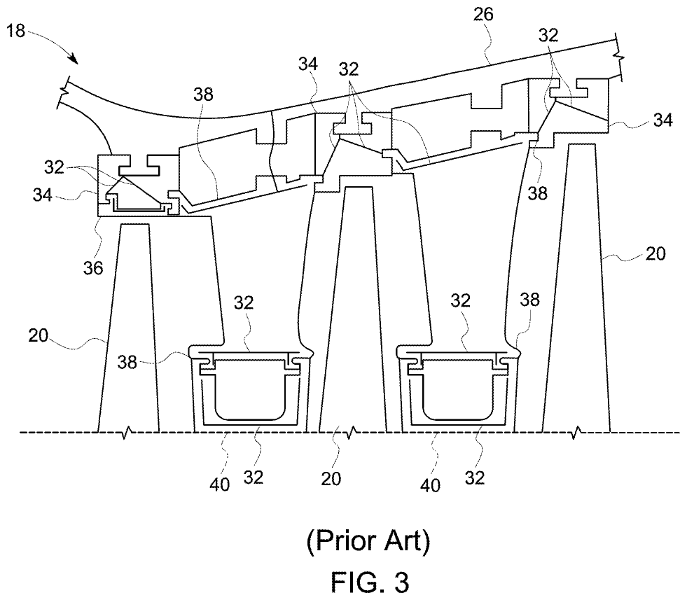

Referring to FIG. 3, a cross-sectional view of one embodiment of turbine 18 of gas turbine 10 (FIG. 1) is shown. In this embodiment, the casing 26 encloses a plurality of outer shrouds 34, an inner shroud 36, a plurality of nozzle blocks 38, a plurality of diaphragms 40, and turbine blades 20. Each of the outer shrouds 34, inner shroud 36, nozzle blocks 38 and diaphragms 40 form a part of the arcuate components 30. Each of the outer shrouds 34, inner shrouds 36, nozzle blocks 38 and diaphragms 40 have one or more slots 32 in a side thereof. In this embodiment, the plurality of outer shrouds 34 connect to the casing 26; the inner shroud 36 connects to the plurality of outer shrouds 34; the plurality of nozzle blocks 38 connect to the plurality of outer shrouds 34; and the plurality of diaphragms 40 connect to the plurality of nozzle blocks 38. A person skilled in the art will readily recognize that many different arrangements and geometries of arcuate components are possible. Alternative embodiments may include different arcuate component geometries, more arcuate components, or less arcuate components.

Cooling air is typically used to actively cool and/or purge the static hot gas path (bled from the compressor of the gas turbine engine 10) leaks through the inter-segment gaps 33 for each set of nozzles and shrouds. This leakage has a negative effect on overall engine performance and efficiency because it is parasitic to the thermodynamic cycle and it has little if any benefit to the cooling design of the hot HGP component. As previously indicated, seals are typically incorporated into the inter-segment gaps 33 of static HGP components to reduce leakage. The one or more slots 32 provide for placement of such seals at the end of each arcuate component 30. It is understood that according to various embodiments, the seals are typically straight, rectangular solid pieces of various types of construction and may include any type of planar seal, such as a standard spline seal, solid seal, shaped seal (e.g. dog-bone), or the like.

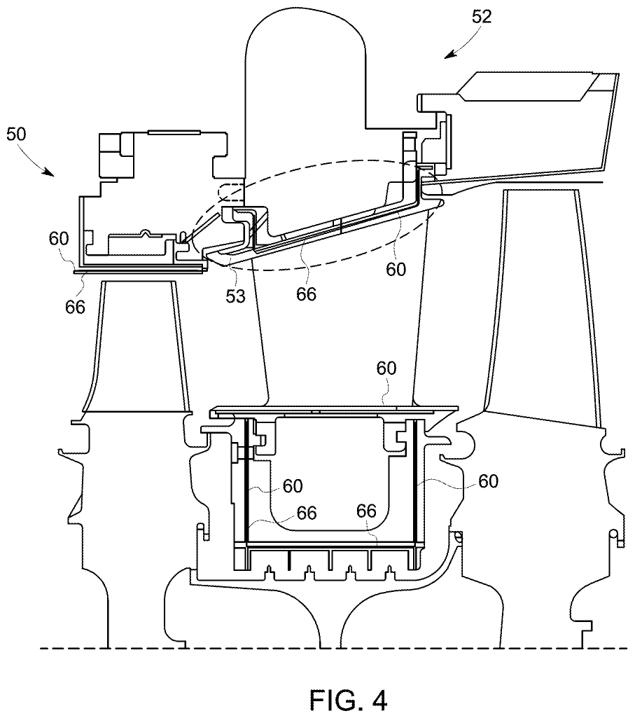

Turning to FIG. 4, a cross-sectional partial longitudinal view of a gas turbine 50, generally similar to gas turbine 10 of FIGS. 1-3, is shown in FIG. 4, according to an embodiment. FIG. 4 shows an end view of an exemplary, and more particularly, a first arcuate component 52, generally similar to one of the plurality of arcuate components 30 of FIG. 2, having a plurality of seals, as disclosed herein, disposed relative thereto.

As illustrated in FIG. 4, the first arcuate component 52 includes one or more slots 60 formed in an end face 53 of the first arcuate component 52. The one or more slots 60 may be comprised of multiple slot portions formed at an angle in relation to each other and connected to one another, or as a single horizontally extending slot 60. More particularly, the one or more slots 60 may be comprised of any number of intersecting or connected slot portions. Alternate configurations of the slot(s) 60 are anticipated.

In the illustrated embodiment of FIG. 4, the gas turbine 50 includes a seal 66 disposed in each of the one or more slots 60. It should be understood that the description of the seal 66 will be described below in relation to a single slot 60 of the arcuate component 52, but is similarly applicable to one or more slots of an adjacent arcuate component upon disposing therein the one or more slots.

As previously stated, gas turbines and engines are slated to function at temperatures above 1800° F. As such, the seal 66 must be suitable for use in harsh environments at such temperatures. Ceramic materials, and particularly, zirconia based materials are widely used as a high temperature thermal barrier coating on gas turbine parts such as blades, vanes, buckets, shrouds etc. because of their high temperature capability, high refractoriness, low thermal conductivity, high toughness, low reactivity to the glassy dust and relative ease of deposition by plasma spraying, flame spraying and physical vapor deposition (PVD) techniques. As an example, zirconia is usually employed in a fully- or partially-stabilized form, by being blended with minor amounts of certain materials, e.g., oxides such as yttrium oxide (yttria), magnesia, scandia, calcium oxide, or various rare earth oxides. As an example, yttria stabilized zirconia (YSZ) is often used. The t′ phase of yttria stabilized zirconia (YSZ) is formed and stabilized predominantly by quenching from a melt and/or vapor phase. Air plasma spraying (APS) is the most scalable process to form these coatings commercially and has the advantages of relatively low equipment costs and ease of application and masking.

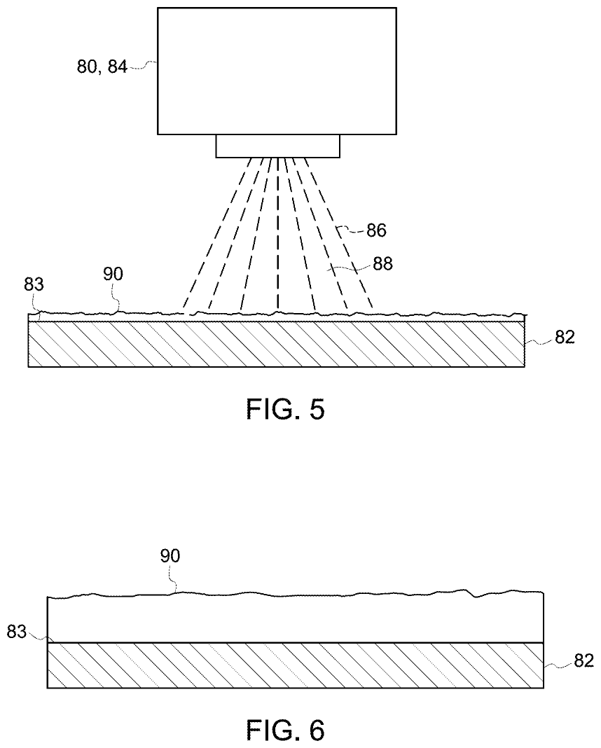

Referring now to FIGS. 5-9, illustrated are steps in a method of fabricating one or more seals 66, described herein as a freestanding ceramic seal. The method is used to ultimately form a freestanding t′ phase of yttria stabilized zirconia (YSZ) ceramic component that can be shaped and optionally finished to function as the seal 66, and more particularly as a seal in a gas turbine, such as gas turbine 10 of FIG. 1. Alternatively, the seal 66 may be used in power generation, aviation engines, or any system that operates within a thermally and chemically hostile environment.

Referring now to FIG. 5, illustrated is a step in the method of forming a freestanding seal, such as the seal 66 as previously described. In an embodiment, a ceramic material is applied over the substantially smooth substrate by air plasma spraying (APS). The plasma techniques are generally known in the art. (See, for example, U.S. Pat. No. 5,332,598 (Kawasaki et al); U.S. Pat. No. 5,047,612 (Savkar and Liliquist); U.S. Pat. No. 4,741,286 (Itoh et al); and U.S. Pat. No. 4,455,470 (Klein et al)). These references are instructive in regard to various aspects of plasma spraying and are incorporated herein by reference. Those of ordinary skill in the plasma spray coating art are familiar with other details which are relevant to applying coatings by APS techniques. Examples of the other steps and process parameters include: cleaning of the surface prior to deposition; grit blasting to remove oxides; substrate temperature; plasma spray parameters such as spray distances (gun-to-substrate); selection of the number of spray-passes, powder feed rate, torch power, plasma gas selection; angle-of-deposition, post-treatment of the applied coating; and the like. Any number of parameters are associated with the effective deposition of a ceramic layer from an APS system including coating particle size, and particle velocity. See, for example, an article by Berghaus, et. al., entitled “Injection Conditions and in-Flight Particle States in Suspension Plasma Spraying of Alumina and Zirconia Nano-Ceramics,” Proceeding of 2005 International Thermal Spray Conference, Basel, Switzerland, May, 2005). In addition, further information regarding the deposition of ceramic materials by air plasma spray techniques is discussed in commonly assigned, U.S. Pub. No. 2009/0162670A1, Yuk-Chiu, L. et al., “Method for Applying Ceramic Coatings to Smooth Surfaces by Air Plasma Spray Techniques, and Related Articles”, which is incorporated herein in its entirety.

More particularly, in the embodiment of FIG. 5, illustrated is a thermal spray system 80 and a substrate 82 onto which a ceramic material, according to this disclosure, is deposited. In an embodiment, the thermal spray system 80 may include an air plasma spray (APS) system, a low pressure plasma spray system, a high velocity oxy-fuel thermal spraying system, an electron beam physical vapor deposition system, or a vacuum plasma spray system. In an embodiment, the substrate 82 is comprised of a metal, such as, an aluminum base alloy, a nickel base alloy, an iron base alloy, a cobalt base alloy, or the like. In an embodiment, the substrate 82 is comprised of a pretreated metal. In an embodiment, the substrate 82 is comprised of a non-metallic material such as one or more of graphite, quartz, silicon carbide, or the like. In the illustrated embodiment, the thermal spray apparatus 80 is a plasma spray system 84 that utilizes an electric arc (not shown) to generate a stream of high temperature plasma gas 86, which acts as the spraying heat source. A ceramic material 88, in a powder form, is carried in an inert gas stream (not shown) into the stream of high temperature plasma gas 86 where it is heated and propelled towards a surface 83 of the substrate 82 to form a layer 90 of the ceramic material 88. In the disclosed embodiment of the seal 66, the ceramic material 88 is yttria-stabilized zirconia (YSZ) in which the crystal structure of zirconium dioxide is made stable at room temperature by an addition of yttrium oxide. More particularly, in an embodiment the ceramic material 86 is yttria-stabilized zirconia (YSZ), having a composition of about 3 to about 8 weight percent yttria. The thermal spray apparatus 80 forms the layer 90 of ceramic material 88 by melting the YSZ ceramic powder 88 in the stream of high temperature plasma gas 86 and then quenching the molten particles of the YSZ ceramic powder 88 onto the substrate surface 83 which is at a substantially lower temperature than the molten ceramic material. The impingement and extremely rapid solidification of the molten particles of the YSZ ceramic powder 88 onto the substrate surface 83 produces a metastable crystal phase of yttria stabilized zirconia known as tetragonal prime (t′). This metastable phase is also referred to in the industry as a non-transformable phase in that the t′ is considered stable below about 1200° C. and retains significantly higher fracture toughness when compared to other phases of YSZ that may be present if produced by other processing methods, compositions, and environmental phase destabilization mechanisms. The mechanical requirements for a functional ceramic seal necessitate that the t′ phase is mainly the predominant phase.

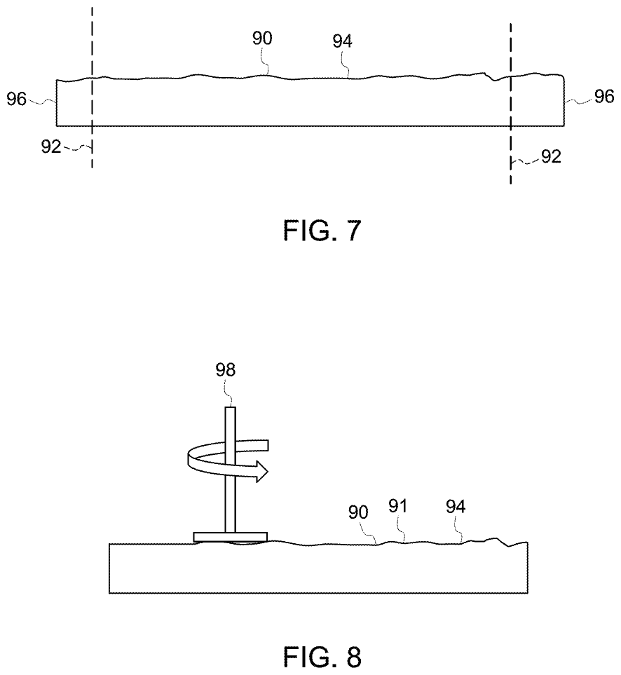

As best illustrated in FIG. 6, the layer 90 of ceramic material is formed on the surface 83 of the substrate 82. As indicated in FIGS. 7 and 8, in a next step, the substrate 82 is removed prior to further processing of the ceramic layer 90. Depending on the specific materials and processes, the substrate 82 may be removed using mechanical (for example, cutting), thermal (for example combustion) or chemical (for example, dissolution in a solvent) means or using a combination thereof. More particularly, subsequent to formation of the layer 90, the ceramic layer 90 is recovered by removing the substrate 82. In an embodiment, the substrate 82 may be mechanically, chemically, or thermally removed during this step, such as by cutting, leaching, dissolving, melting, oxidizing, etching, or any other similar method that provides for removal of the substrate 82, without damage to the ceramic layer 90. In an embodiment, the substrate 82 is etched away in a suitable etching medium, such as acid or alkali etchant. In an embodiment the etchant medium may include combinations of nitric and hydrofluoric acids. In an embodiment the substrate 82 is removed using a concentrated nitric acid (e.g., 67%, 50%, 40% and so forth) flush. In other embodiments, concentrated hydrochloric acid may be used to remove the substrate 82. In an embodiment, the etchant medium is a mixture of nitric acid, hydrochloric acid, and deionized water.

Referring still to FIGS. 7 and 8, the freestanding ceramic layer 90, having now had the substrate 82 removed, is finished to the required dimensions, strength, density, surface texture and/or shape to function as a freestanding seal, and more particularly to form the freestanding ceramic seal 66 (FIG. 4). As best illustrated in FIG. 7, the ceramic layer 90 is cut, as indicated by dashed lines 92, to define a portion 94 that will define the seal 66 and one or more portions 96 that will be discarded. In an embodiment, the ceramic layer 90 is mechanically cut to define substantially the finished dimensions of the seal 66. More particularly, the ceramic layer 90 is cut so as to form it into the required shaped to function as the seal 66.

As best illustrated in FIG. 8, a surface 91 of the ceramic layer 90, and more particularly the portion 94, is next finished, such as through grinding, honing, lapping and/or polishing, to produce the desired smoothness, roughness, dimensions, or the like of the finished seal 66. Any conventional finishing step can be undertaken, as long as the technique does not damage the ceramic layer 90. Non-limiting examples include grit blasting, hand sanding with fine abrasive paper, and mechanical polishing/buffing. Grit blasting can itself be carried out in a number of ways. As one example, a light grit-blasting step can be carried out by directing a pressurized air stream containing silicon carbide particles across the surface of the ceramic layer 90 at a pressure of less than about 80 psi. In the illustrated embodiment, the portion 94 of the ceramic layer 90 is polished/buffed mechanically using a vertical spindle and polishing pad 98 which rotates at high speed, as indicated by the directional arrow, and a suitable polishing medium. In some particular embodiments, the seal 66 is finished having a thickness of approximately 0.05 millimeters to approximately 3.0 millimeters, and more particularly a thickness of approximately 0.125 millimeters to 2.5 millimeters. In an embodiment, the seal 66 is finished having a width and overall length substantially equivalent to the width and overall length of the seal slot 60 (FIG. 4) into which it is disposed.

In an additional step, to increase strength of the ceramic layer 90, further post-processing steps may be performed. In an embodiment, depending on the density of the ceramic layer 90, the ceramic layer 90 can be densified to closed porosity or infiltrated with a sinteractive precursor solution or slurry, and sintered to closed porosity, so as to prevent leakage of gaseous phases of combustion and add additional strength.

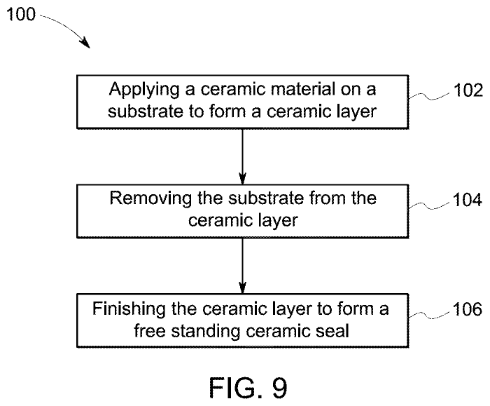

It should be understood that subsequent to removal of the substrate 82, as described above with reference to FIG. 6, the final finishing of the ceramic layer 90, including cutting as described in FIG. 7, surface finishing and shaping as described in FIG. 8, and/or additional post processing steps as described in FIG. 9, may be conducted in any order so as to achieve the desired resultant freestanding ceramic seal 66.

FIG. 10 is a flow diagram illustrating a method 100 of forming a seal in a gas turbine according to the various Figures. The method can include the following processes:

Process P1, indicated at 102, includes disposing a ceramic material on a substrate to form a ceramic layer. The ceramic material comprising yttria-stabilized zirconia (YSZ) with a t′ phase tetragonal structure. In an embodiment, the substrate comprises a metal, such as an austenitic nickel-chromium super alloy, and more particularly Inconel®.

Process P2, indicated at 104, includes removing the substrate from the ceramic layer. Removal of the substrate may be accomplished using any of a mechanical means (for example, cutting), a thermal means (for example combustion), a plasma-based means (for example plasma etching) or a chemical means (for example, dissolution in a solvent) means or using a combination thereof.

In Process P3, indicated at 106, the ceramic layer 90, having now had the substrate 82 removed, is finished to the required dimensions, strength, density, surface texture and/or shape to function as a freestanding seal, and more particularly to form the freestanding ceramic seal 66 (FIG. 4). The finishing of the ceramic layer 90 in this step, may include, but is not limited to, cutting as described with regard to FIG. 7, surface finishing as described with regard to FIG. 8, and/or additional post processing steps as previously described, to achieve the desired resultant seal 66. Subsequent to fabrication of the seal 66, in an embodiment the seal 66 is applied to a turbine (e.g., gas turbine 10, FIG. 1), where applying includes inserting the seal 66 in a slot 60.

The primary requirement of high refractoriness and toughness of the freestanding seal component, and more particularly the seal 66, is provided by the t′ phase of the yttria-stabilized zirconia of which it is fabricated, made feasible by the quench forming process of thermal spraying on a substrate in large areas. The resulting freestanding seal 66 exhibits high refractoriness (thermal stability), high toughness (abrasion and impact resistance), and the ability to fabricate to various thicknesses, while providing reduced manufacturing costs.

It is understood that in the method shown and described herein, other processes may be performed while not being shown, and the order of processes can be rearranged according to various embodiments. Additionally, intermediate processes may be performed between one or more described processes. The flow of processes shown and described herein is not to be construed as limiting of the various embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of forming a freestanding ceramic seal for sealing in a gas turbine comprising:
applying a ceramic material on a substrate to form a ceramic layer;
removing the substrate from the ceramic layer; and
finishing the ceramic layer to define the freestanding ceramic seal.

2. The method of claim 1, wherein the substrate is comprised of one of a metal or metal alloy.

3. The method of claim 1, wherein the step of applying a ceramic material on a substrate to form a ceramic layer includes depositing particles of the ceramic material in one of a molten or vapor state on a surface of the substrate and quenching the ceramic material to form the ceramic layer.

4. The method of claim 1, wherein the step of applying a ceramic material on a substrate to form a ceramic layer comprises applying using a thermal spray deposition process.

5. The method of claim 4, wherein the ceramic material forming the ceramic layer has been applied to the substrate by an air plasma spraying (APS) technique.

6. The method of claim 1, wherein the ceramic material comprises yttria-stabilized zirconia.

7. The method of claim 6, wherein the yttria-stabilized zirconia has predominantly a t′ tetragonal structure.

8. The method of claim 6, wherein the yttria-stabilized zirconia (YSZ) comprises 3 to 8 weight percent yttria.

9. The method of claim 1, wherein removing the substrate includes removing using at least one of a mechanical means, a thermal means, and a chemical means.

10. The method of claim 1, wherein removing the substrate includes removing by etching the substrate away using one of an acid or an alkali.

11. The method of claim 1, wherein finishing the ceramic layer to define the freestanding ceramic seal includes at least one of cutting, polishing, buffing, honing, sintering to close porosity, and infiltrating with a sinteractive precursor prior to sintering to close porosity.

12. The method of claim 1, wherein finishing the ceramic layer to define the freestanding ceramic seal includes finishing to one or more of required dimensions, strength, density, surface texture and shape to function as the freestanding ceramic seal.

13. The method of claim 1, further comprising post processing steps to increase a strength of the ceramic layer.

14. A freestanding ceramic seal to seal a gas turbine hot gas path flow in a gas turbine, the freestanding ceramic seal comprised of yttria-stabilized zirconia (YSZ).

15. The freestanding ceramic seal of claim 14, wherein the yttria-stabilized zirconia (YSZ) has a t′ tetragonal structure.

16. The freestanding ceramic seal of claim 15, wherein the yttria-stabilized zirconia (YSZ) comprises 3 to 8 weight percent yttria.

17. The freestanding ceramic seal of claim 14, wherein the free-standing ceramic seal is one of a spline seal, a solid seal, or a shaped seal.

18. The freestanding ceramic seal of claim 14, wherein the free-standing ceramic seal has a thickness of 0.05 millimeters to approximately 3.0 millimeters.

19. A gas turbine comprising:
a first arcuate component adjacent to a second arcuate component, each arcuate component including one or more slots located in an end face; and
a seal disposed in the slot of the first arcuate component and the slot of the second arcuate component, the seal comprising:
a free-standing ceramic seal comprised of yttria-stabilized zirconia (YSZ) having a t′ tetragonal structure.

20. The gas turbine of claim 19, wherein the free-standing ceramic seal is one of a spline seal, a solid seal, or a shaped seal.
